(19) United States
(12) Patent Application Publication
(10) Pub. No.: US 2013/0274051 A1
(43) Pub. Date: Oct. 17, 2013

(54) DRIVE DEVICE FOR A MOTOR VEHICLE

(71) Applicant: SIEMENS AKTIENGESELLSCHAFT, Munchen (DE)

(72) Inventors: Klaus Kalmbach, Mossingen (DE); Klaus Schleicher, Nurnberg (DE); Janina Steinz, Stuttgart (DE)

(73) Assignee: Siemens Aktiengesellschaft, Munchen (DE)

(21) Appl. No.: 13/862,942

(22) Filed: Apr. 15, 2013

(30) Foreign Application Priority Data
Apr. 16, 2012 (DE) 10 2012 206 143.6

(51) Int. Cl. F16H 57/037; F16H 57/031

(52) U.S. Cl. CPC F16H 57/037; F16H 57/031
USPC 475/150; 74/606 R; 475/149; 74/421 A

(57) ABSTRACT

A drive device for a motor vehicle includes at least one electric machine having at least one rotor element which is configured to delimit an installation area in a radial direction. At least one transmission device is disposed, at least partly, in the installation area and configured to be driven by the electric machine via the rotor element. At least two components of the transmission device and/or electric machine are permanently linked to one another such that a detachment of the two components causes destruction.

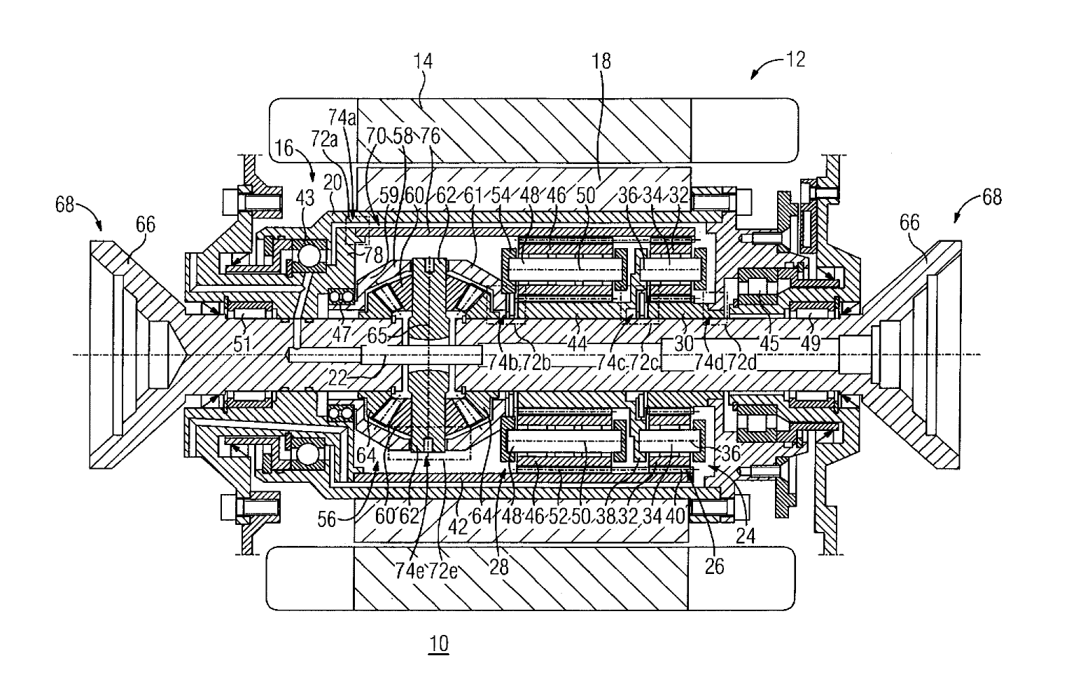

### CROSS-REFERENCES TO RELATED APPLICATIONS

This application claims the priority of German Patent Application, Ser. No. DE 10 2012 206 143.6, filed Apr. 16, 2012, pursuant to 35 U.S.C. 119(a)-(d), the content of which is incorporated herein by reference in its entirety as if fully set forth herein.

### BACKGROUND OF THE INVENTION

The present invention relates to a drive device for a motor vehicle.

The following discussion of related art is provided to assist the reader in understanding the advantages of the invention, and is not to be construed as an admission that this related art is prior art to this invention.

Drive devices for motor vehicles have been described in the prior art and are also known from series production of motor vehicles, especially of automobiles. Typically, a drive device includes a drive unit and if necessary a transmission, via which the motor vehicle is able to be driven. The drive unit involves an internal combustion engine for example. As an alternative the drive unit can involve an electric machine which can drive the motor vehicle in a motor mode. Conventional drive devices are bulky and demand much installation space.

It would therefore be desirable and advantageous to provide an improved drive device to obviate prior art shortcomings.

### SUMMARY OF THE INVENTION

According to one aspect of the present invention, a drive device for a motor vehicle includes at least one electric machine having at least one rotor element which is configured to delimit an installation area in a radial direction, at least one transmission device disposed, at least partly, in the installation area and configured to be driven by the electric machine via the rotor element; and at least two components permanently linked to one another such that a detachment of the two components causes destruction.

The rotor element can comprise a rotor carrier and an active rotor part. As the at least one transmission device can be driven via the rotor element of the electric machine, torque provided by the electric machine can be introduced via the rotor element into the transmission device. The transmission device serves in this case to convert and/or to transmit the torque. Through integration of the transmission unit into the rotor element, the installation space required for a drive device according to the invention is particularly small. The transmission device does not adjoin the rotor element in the axial direction and is not linked in the axial direction to the rotor element but is surrounded and covered over in the radial direction by the rotor element at least partly, especially completely. Thus a loss of axial installation space which would result from disposing the transmission device in the axial direction next to the rotor element is avoided so that a drive device according to the invention requires little installation space, especially in the axial direction of the rotor element.

As a result of a permanent connection of at least two components to one another, so that a detachment from one another is not possible without destroying them, the need for connections such as for example screws or the like for reversible releasable connection of the components as well as the corresponding attachment areas for these connections can be dispensed with and saved, thereby rendering a drive device according to the invention especially compact.

Reversibly-releasable connections, which for example may involve flanged connections between the components, generally require much installation space and increase weight. By eliminating these types of connections in the drive device, weight can be saved. As there are no flange connections, the radial installation space of a drive device according to the invention can also be kept especially small. The need for little radial installation space also makes it possible to present especially high efficiencies of the transmission device and the electric machine, so that the motor vehicle can be driven in an energy-efficient manner and can cover a long range.

A drive device can be manufactured at low costs, since the components, as a result of their not being linked to one another in a non-destructively releasable manner, can be manufactured as delicate components and thus with only a small outlay in materials. In addition the connection between the components not able to be released non-destructively is highly failsafe in view of the absence of any connections that could become loose during operation of the transmission device. The delicate and thus light configuration of the components also makes it possible for example—if the components are rotating components during the operation of the drive device—to realize especially low moments of inertia of the drive device.

According to another advantageous feature of the present invention, the components can be connected to one another by a material bond. In this way, a solid and also space-saving and low-cost connection of the components can be realized. The components may hereby be glued to one another.

According to another advantageous feature of the present invention, the components can be welded to one another. This results in an especially firm connection of the components to one another. Very high torques can therefore be transmitted between the components for example. Advantageously, welding may be executed by electron beam welding and/or by laser welding. Through the electron beam welding and laser welding the components can be welded solidly to one another and thus at low cost. Electron beam welding in particular, which is also referred to as EB welding, is especially advantageous, since electron beam welding is very effective and can be performed efficiently.

According to another advantageous feature of the present invention, the transmission device can have a first housing element which defines a first one of the components. This enables the other components or other types of components of the drive device to be attached in a low-cost and space-saving manner to the especially stationary transmission housing element. Advantageously, the transmission device can have a second housing element which defines a second one of the components. The transmission housing can thus be embodied in at least two parts, i.e. first and second housing elements which are linked to one another in a space-saving manner.

According to another advantageous feature of the present invention, the transmission device can include at least one planetary gear having a planetary carrier which includes a first planetary carrier part to define a first one of the components and a second planetary carrier part to define a second one of the components, and at least one planetary wheel element supported on the planetary carrier. The planetary carrier can thus be embodied in at least two parts with the two planetary carrier parts, which are linked to one another, especially welded to one another, in a space-saving and low-cost manner.

It should however be noted at this point that the at least one transmission stage can also have a different embodiment.

To realize an advantageous installation of the planetary carrier and especially a simple equipping of the planetary carrier with the planetary wheel elements, the first and second planetary carrier parts may be disposed next to one another in an axial direction. Thus, the planetary carrier can be embodied axially divided.

Manufacture of a drive device according to the invention may involve, for example, initially a mounting of the planetary wheel element on one of the planetary carrier parts, after which the one of the planetary carrier parts is linked, especially welded, to the other planetary carrier part so that it cannot be released non-destructively. Advantageously, all planetary wheel elements of the planetary gear are first mounted on the one planetary carrier part, after which the planetary carrier parts are linked to one another in a manner that is not non-destructive.

According to another advantageous feature of the present invention, the transmission device can include a differential gear having a differential case which includes a first case part to define a first one of the components and a second case part disposed next to the first case part to define a second one of the components, and balance wheels supported on the differential case. The differential gear makes it possible for the motor vehicle to be driven very advantageously by the drive device, since, by means of the differential gear, different speeds of wheels of the motor vehicle driven via the differential gear, for example when the motor vehicle is negotiating a curve, are made possible, without this resulting in stress on the drive device.

The at least two-part construction of the differential gear or of its differential case enables the balance wheels and/or so-called shaft wheels to be initially mounted or supported in a time-saving and low-cost manner, after which the case parts are linked, especially welded, to one another without the use of a non-destructive connection. The shaft wheels can be coupled to drive shafts, wherein the wheels of the motor vehicle are driven via the drive shafts. To realize an especially simple installation of the differential gear, the case parts are disposed next to one another in an axial direction. As a result, the case parts are axially divided in an advantageous embodiment.

As part of the manufacturing of the drive device, there is provision for example for all balance wheels and/or all shaft wheels of the differential gear to be mounted on the one case part, after which the one case part is linked in a manner which is not non-destructive to the other case part and thus in an especially space-saving manner.

According to another advantageous feature of the present invention, the transmission device can include a first toothed wheel to define a first one of the components and a second toothed wheel to define a second one of the components. This makes an especially advantageous torque transmission between the toothed wheels possible. Advantageously, the toothed wheels are disposed in coaxial spaced-apart relationship to one another in the axial direction, so that the connection of the toothed wheels not able to be released non-destructively enables a transmission of torque between the toothed wheels is possible although these do not engage with one another via respective teeth.

According to another advantageous feature of the present invention, the first toothed wheel can be operatively connected to a first transmission stage of the transmission device, and the second toothed wheel is operatively connected to a second transmission stage of the transmission device. This makes it possible to transmit especially high torques in a space-saving and efficient manner between the individual transmission stages without the transmission stages engaging with one another via respective teeth and being coupled to one another in this way.

Advantageously, all toothed wheels which are respective components of the transmission device and which are solidly linked to one another, are linked to one another using a connection which is not able to be released non-destructively. This presents an efficient and space-saving transmission even of very high torques between the toothed wheels, which leads to a high efficiency of the transmission device and thereby of the drive device.

According to another advantageous feature of the present invention, the transmission device can include a first planetary gear having a sun wheel to define one of the first and second components. Thus, torque can be transmitted very efficiently and advantageously to the sun wheel. The sun wheel functions for example as an input element of the corresponding planetary gear. In other words, torque of the electric machine provided by the sun wheel is introduced into the corresponding planetary gear. Advantageously, the transmission device can have a second planetary gear connected upstream of the first planetary gear and including a planetary carrier to define another one of the first and second components. As a result, torque supplied by the electric machine can be transmitted via the rotor element and the at least one housing element to the sun wheel and be introduced into the corresponding planetary gear.

As an alternative it is possible for the sun wheel to be a first one of the components, wherein a planetary carrier of a further planetary gear of the transmission device which is connected upstream from the planetary gear with the sun wheel is the second component. The planetary carrier can in this case be the planetary carrier previously described. Through this connection not able to be released non-destructively of the planetary carrier of the further planetary gear with the sun wheel of the first planetary gear connected downstream from the further planetary gear, the two planetary gears are linked to one another in a space-saving and efficient manner, so that even especially high torques can be transmitted between them.

According to another advantageous feature of the present invention, one of the components may be a planetary carrier of a planetary gear of the transmission device. The planetary carrier in this case can be the planetary carrier previously described. The planetary carrier is preferably used as an output element of the assigned planetary gear. In other words torques introduced into the gear element assigned to the planetary carrier are taken off via the planetary carrier from the assigned planetary gear or derived from this gear.

According to another advantageous feature of the present invention, one of the components may be a differential case of a differential gear of the transmission device. The differential gear in this case can be the differential gear previously described. This configuration enables torque to be introduced especially efficiently and also in a space-saving and low-cost manner into the differential transmission and also taken off from this transmission.

In this case there is provision for example for the differential gear to be coupled to a planetary carrier of an associated planetary gear. The planetary carrier can in this case be the planetary carrier previously described. In particular this planetary carrier is an output element of the associated planetary gear, which in relation to the flow of force and/or torque from the rotor element to the differential gear, is the last of a number of gear stages of the transmission device.

Advantageously, all wheel sets of the transmission device may be connected to one another in the direction of a flow of force and/or torque in a manner which is not non-destructive. This makes a space-saving transmission of even very high torques between the wheel sets possible.

### BRIEF DESCRIPTION OF THE DRAWING

Other features and advantages of the present invention will be more readily apparent upon reading the following description of currently preferred exemplified embodiments of the invention with reference to the accompanying drawing, in which the sole FIGURE shows a schematic longitudinal sectional view of a drive device for a motor vehicle.

### DETAILED DESCRIPTION OF PREFERRED EMBODIMENTS

The depicted embodiment is to be understood as illustrative of the invention and not as limiting in any way. It should also be understood that the figure is not necessarily to scale and that the embodiment may be illustrated by graphic symbols, phantom lines, diagrammatic representations and fragmentary views. In certain instances, details which are not necessary for an understanding of the present invention or which render other details difficult to perceive may have been omitted. The features and combinations of features specified in the description as well as the features and combinations of features specified in the description of the FIGURE and/or in the FIGURE alone are able to be used not only in the respectively specified combination, but also in other combinations or on their own, without departing from the framework of the invention.

Turning now to the FIGURE, there is shown a schematic longitudinal sectional view of a drive device for a motor vehicle embodied for example as a hybrid or electric vehicle, with an electric machine having a rotor element into which a transmission device having two transmission stages is integrated with a differential gear connected serially downstream from one of the transmission stages.

The sole FIGURE shows a drive device according to the present invention, generally designated by reference numeral 10 for a motor vehicle, which is embodied for example as an automobile. The motor vehicle can also be embodied as a hybrid vehicle or as an electric vehicle, especially with a range extender.

The drive device 10 includes an electric machine 12 having a stator 14, shown schematically only, and a rotor element 16, also shown schematically. The rotor element 16 has an active rotor part 18 with a magnetic circuit comprised of coils and/or magnets as well as a rotor carrier 20, to which the active rotor part 18 is attached. The rotor element 16 is rotatable about an axis of rotation 22.

The drive device 10 additionally includes a transmission device 24, which has, as its first transmission stage, a first planetary gear 26 and, as its second transmission stage, a second planetary gear 28. The first planetary gear 26 has a first sun wheel 30, which is rotatable about the axis of rotation 22 and coupled with the rotor carrier 20. As a result, torque provided by the electric machine 12, when operating in a motor mode via the rotor carrier 20 for example, is introduced into the first sun wheel 30, so that the first sun wheel 30 is driven by the rotor carrier 20. The first planetary gear 26 has a plurality of first planetary wheel elements 32 in mesh with the first sun wheel 30 via respective teeth. The first planetary gear elements 32 are supported on respective first planetary wheel studs 34 rotatable around an axis of rotation 36 and also via the first planetary wheel studs 34 on a first planetary gear carrier 38 of the first planetary gear 26. The first planetary wheel elements 32 can also rotate about the axis of rotation 22.

Furthermore, the first planetary gear 26 has a first stationary hollow wheel 40, which is integrated into a transmission housing 42 of the transmission device 24. Thus, the transmission housing 42 and the first hollow wheel 40 are embodied in one piece with one another, wherein the first hollow wheel 40 does not rotate about the axis of rotation 22 during operation of the drive device 10. The first planetary wheel elements 32 are hereby in mesh via teeth with the first hollow wheel 40. Of course, the presence of a rotating hollow wheel is also conceivable. In addition, it would be conceivable to support the rotor carrier 20 directly on the hollow wheel outer diameter, for example via a friction bearing, as with turbochargers, or via needle bearings.

The second planetary gear 28 has a second sun wheel 44, which is rotatable about the axis of rotation 22 and coupled or linked to the first planetary carrier 38. As a result, the second sun wheel 44 is driven via the first planetary carrier 38 when the drive device 10 is operated. The second planetary gear 28 also includes a plurality of second planetary wheel elements 46 in mesh via teeth with the second sun wheel 44. The second planetary wheel elements 46 are supported rotatably on respective second planetary wheel studs 48 around respective axes of rotation 50 and can also rotate around the axis of rotation 22.

The second planetary gear 28 has a stationary second hollow wheel 52 in mesh via teeth with the second planetary wheel elements 46 and likewise integrated into the transmission housing 42. A second rotating hollow wheel might also be conceivable. In addition it would be conceivable to support the rotor carrier 20 directly on the hollow wheel outer diameter, for example via a friction bearing, such as with turbochargers, or via needle bearings. The second planetary wheel elements 46 are supported or braced by their second planetary wheel studs 48 on a second planetary carrier 54.

The transmission device 24 additionally includes a differential gear 56 with a so-called differential case 58. The differential gear 56 also has a plurality of balance wheels 60, which are supported rotatably via respective balance studs 62 on the differential case 58 around an axis of rotation 65. Furthermore the differential gear 56 has shaft wheels 64, which are linked via teeth to drive shafts 66 in a torque-proof manner. The drive shafts 66 have respective connections 68, via which driven wheels of the vehicle can be linked in a torque-proof manner to the drive shafts 66.

As can be seen from the FIGURE, the differential gear 56 is embodied as a bevel differential gear, wherein the balance wheels 60 and the shaft wheels 64 are embodied as bevel gears meshing with each other via teeth. The differential gear 56 has four balance wheels 60 for example.

As can also be seen from the FIGURE, the transmission device 24 is not flanged into the rotor element 16 in axial arrangement, but by contrast is integrated into the rotor element 16.

The rotor element 16 delimits an installation area 70 in a radial direction, in which the two-stage transmission device 24 is housed with the differential gear 56. The differential gear 56 and/or the first planetary gear 26 may hereby project in the axial direction beyond the active rotor part 18; however neither the differential gear 56 nor the first planetary gear 26 projects beyond the rotor carrier 20 in the axial direction, so that the planetary gears 26, 28 and the differential gear 56 are completely accommodated in the installation area 70 and are surrounded and covered in the radial direction by the rotor element 16, especially the rotor carrier 20.

This projection beyond the active rotor part 18 by the differential gear 56 and/or the first planetary gear 26 in the axial direction can however be avoided with a different ratio of rotor length/diameter/speed/torque.

This avoids loss of installation space in an axial direction, since neither the differential gear 56 nor the planetary gear 26, 28 are flanged axially onto the rotor element 16. In addition, there is an at least essentially ideal and direct distribution of the torque provided by the electric machine 12 in its motor mode via its rotor element 16 at least essentially from the axial center of the rotor element 16 to the two drive shafts 66.

In its motor mode, a flow of force and/or torque is established from the electric machine 12 via its rotor element 16 and especially its rotor carrier 20 via the planetary gear 26, 28 and the differential gear 56 to the drive shafts 66. The rotor element 16, the planetary gear 26, 28 and the differential gear 56 are hereby connected in series with one another in relation to the force and/or torque flow.

The first sun wheel 30 functions as first input element of the planetary gear 26, since torque is introduced into the first planetary gear 26 via the first sun wheel 30. The first planetary carrier 38 functions as first output element of the first planetary gear 26, since torque is derived from the first planetary gear 26.

The second sun wheel 44 linked to the first planetary carrier 38 functions as a second input element of the second planetary gear 28, while the second planetary carrier 54 of the second planetary gear 28 serves as a second output element of the second planetary gear 28 and is linked to the differential gear 56, especially to its differential case 58. In other words, the differential case 58 of the differential gear 56 is driven via the second planetary carrier 54, so that the balance wheels 60, and via these the shaft wheels 64, are rotated around the axis of rotation 22 via the differential case 58. Thus the drive shafts 66 are driven to also rotate about the axis of rotation 22.

Roller bearings 43, 45 are provided to support the rotor element 16. In addition a further roller bearing 47 is provided for supporting the differential case 58. The drive shafts 66 are supported by roller bearings 49, 51.

Through the integration of the planetary gears 26, 28 and the differential gear 56 into the rotor element 16 as well as the corresponding configuration of the transmission stages as the planetary gears 26, 28, the drive device 10 requires especially little space and makes possible the efficient and effective transmission and conversion of the torque provided by the electric machine 12 through to the drive shafts 66.

Areas 72a-e are indicated in the FIGURE to show connections 74a-e, not able to be released non-destructively, between at least two respective components of the drive device 10 and of the transmission device 24.

Via the first connection 74a not able to be released non-destructively, a first housing element 76 as the first of the components permanently linked to one another and a second housing element 78 as the second of the components permanently linked to one another of the transmission housing 42 are linked to one another by a connection not able to be released non-destructively.

Via the second connection 74b not able to be released non-destructively the second planetary carrier 54 and the differential case 58 are linked to one another by a connection not able to be released non-destructively, so that torques can be introduced especially efficiently from the second planetary carrier 54 into the differential case 58.

Via the third connection 74c not able to be released non-destructively the first planetary carrier 38 of the first planetary gear 26 and the second sun wheel 44 of the second planetary gear 28 are linked to one another by a connection not able to be released non-destructively, so that torques can also be transmitted in an especially efficient and space-saving manner between the first planetary carrier 38 and the second sun wheel 44.

Via the fourth connection 74d not able to be released non-destructively the first sun wheel 30 and the rotor element 16, especially its stator carrier 20, are linked to one another by a connection not able to be released non-destructively, so that at this point too an efficient torque transmission is realized in a space-saving manner.

The differential case 58 is axially divided for example and comprises a first case is part 59 as well is the second case part 61, which are disposed next to one another in the axial direction. The two case part 59, 61 are linked to one another via the fifth connection 74e not able to be released non-destructively. Through this embodiment of the differential case 58 the balance wheels 60 as well as the shaft wheels 64 can be mounted in an especially time-saving and low-cost manner. Furthermore the case parts 59 and 61 are permanently linked to one another.

To present the connections 74a-e not able to be released non-destructively, the corresponding components are preferably welded to one another by means of electron beam welding (EB welding). It should have been noted at this point that another especially non-releasable connection technology can be used for the components linked permanently to one another.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A drive device for a motor vehicle, comprising:
at least one electric machine having at least one rotor element which is configured to delimit an installation area in a radial direction; and
at least one transmission device disposed, at least partly, in the installation area and configured to be driven by the electric machine via the rotor element;
wherein at least two components selected from the group consisting of electric machine and transmission device are permanently linked to one another such that a detachment of the two components causes destruction.

2. The drive device of claim 1, wherein the components are connected to one another by a material bond.

3. The drive device of claim 1, wherein the components are welded to one another.

4. The drive device of claim 3, wherein the components are welded to one another by electron beam welding or by laser welding.

5. The drive device of claim 1, wherein the transmission device has a first housing element which defines a first one of the components.

6. The drive device of claim 5, wherein the transmission device has a second housing element which defines a second one of the components.

7. The drive device of claim 1, wherein the transmission device comprises at least one planetary gear having a planetary carrier which includes a first planetary carrier part to define a first one of the components and a second planetary carrier part to define a second one of the components, and at least one planetary wheel element supported on the planetary carrier.

8. The drive device of claim 7, wherein the first and second planetary carrier parts are disposed next to one another in an axial direction.

9. The drive device of claim 1, wherein the transmission device comprises a differential gear having a differential case which includes a first case part to define a first one of the components and a second case part to define a second one of the components, and balance wheels supported on the differential case.

10. The drive device of claim 9, wherein the second case part is disposed in an axial direction next to the first case part.

11. The drive device of claim 1, wherein the transmission device comprises a first toothed wheel to define a first one of the components and a second toothed wheel to define a second one of the components.

12. The drive device of claim 11, wherein the second toothed wheel is disposed in coaxial spaced-apart relationship to the first toothed wheel.

13. The drive device of claim 11, wherein the first toothed wheel is operatively connected to a first transmission stage of the transmission device, and the second toothed wheel is operatively connected to a second transmission stage of the transmission device.

14. The drive device of claim 1, wherein the transmission device has toothed wheels which are permanently linked to one another such that a detachment of toothed wheels causes destruction.

15. The drive device of claim 1, wherein the transmission device comprises a first planetary gear having a sun wheel to define one of the first and second components.

16. The drive device of claim 15, wherein the rotor element is constructed to define the other one of the first and second components.

17. The drive device of claim 15, wherein the transmission device comprises a second planetary gear connected upstream of the first planetary gear and having a planetary carrier to define the other one of the first and second components.

18. The drive device of claim 1, wherein the transmission device comprises a planetary transmission having a planetary carrier, and a differential gear having a differential case, one of the planetary carrier and the differential case defining one of the first and second components.
